(19) United States
(12) Patent Application Publication
(10) Pub. No.: US 2010/0123571 A1
(43) Pub. Date: May 20, 2010

(54) INSPECTION SYSTEM AND METHOD

(76) Inventors: Christopher W. Crowley, San Diego, CA (US); Brian Lon Ficke, La Jolla, CA (US); Young Kyo Lee, San Diego, CA (US)

Correspondence Address: PATRICK W. RASCHE (22697);ARMSTRONG TEASDALE LLP, ONE METROPOLITAN SQUARE, SUITE 2600, ST. LOUIS, MO, 63102-2740, US

(21) Appl. No.: 12/273,867

(22) Filed: Nov. 19, 2008

(51) Int. Cl. G08B 19/00

(52) U.S. Cl. 340/521

(57) ABSTRACT

A method includes determining a position of a person within an inspection system, and performing a sensor system scan using a sensor system within the inspection system. The sensor system scan includes detecting an unusual physical characteristic of at least one of the person and an item on the person. The results of the sensor system scan are output.

### BACKGROUND OF THE INVENTION

1. Field of the Invention

The embodiments described herein relate generally to inspection systems used to inspect a person and, more particularly, to an inspection system configured to inspect a person for a target material.

2. Description of the Related Art

The Transportation Security Administration (TSA) has recently mandated more stringent inspection procedures be implemented by the travel industry to reduce the possibility of passengers boarding a carrier, such as an aircraft, carrying concealed weapons, explosives, and/or other contraband. To facilitate preventing passengers boarding a plane carrying concealed weapons, explosives, and/or other contraband, the TSA requires that all passengers be screened and/or inspected prior to boarding the carrier.

In some known inspection systems, passengers arriving at the airport terminal first submit to a manual verification process that generally includes presenting a boarding pass and a form of identification, such as a driver's license or passport, to security personnel. The security personnel then manually verify that the passenger has a valid boarding pass, that the name on the identification corresponds to the name on the boarding pass, and that the picture on the identification corresponds to the passenger presenting the identification and the boarding pass to the security personnel. After the manual verification process is completed, the passenger is requested to walk through a metal detector to ensure that the passenger is not carrying any concealed weapon.

While the current passenger screening process is reliable, the process may require additional security personnel to perform the screening procedures. As a result, the cost of implementing an effective passenger screening process at a transportation terminal is increased. Moreover, the time required to perform the screening process is increased, thus, necessitating passengers to arrive relatively early to allow the passenger sufficient time to complete the screening process.

Further, at least some known inspection systems are configured to detect contraband, however, some benign objects may appear to be benign but include and/or conceal a contraband material. As such, there is a need to detect such materials and/or objects.

### BRIEF DESCRIPTION OF THE INVENTION

In one aspect, a method is provided. The method includes determining a position of a person within an inspection system, and performing a sensor system scan using a sensor system within the inspection system. The sensor system scan includes detecting an unusual physical characteristic of at least one of the person and an item on the person. The results of the sensor system scan are output.

In another aspect, an inspection system for inspecting a person for a presence of a target material is provided. The inspection system includes a screening system for performing a target material scan and a sensor system configured to detect an unusual physical characteristic of the person and/or an item on the person.

The embodiments described herein facilitate determining whether an object includes unusual physical characteristics such that the object may be more thoroughly inspected. As used herein, the term “unusual physical characteristic” refers to a measured physical characteristic that deviates from average physical characteristics for a particular object as determined by a model, a range, and/or a threshold. For example, an unusual physical characteristic is a statistical outlier as compared to data for physical characteristics for a sample group of objects.

### BRIEF DESCRIPTION OF THE DRAWINGS

FIGS. 1-8 show exemplary embodiments of the system and method described herein.

FIG. 1 is a perspective view of an exemplary inspection system for inspecting a person.

FIG. 2 is a simplified block diagram of the inspection system shown in FIG. 1.

FIG. 3 is perspective view of a sensor system that may be used with the system shown in FIG. 1.

FIG. 4 is a flowchart of an exemplary embodiment of a method for inspecting a person that may be used with the inspection system shown in FIGS. 1-3.

FIG. 5 is a flowchart of a first alternative embodiment of the method shown in FIG. 4.

FIG. 6 is a flowchart of a second alternative embodiment of the method shown in FIG. 4.

FIG. 7 is a flowchart of a third alternative embodiment of the method shown in FIG. 4.

FIG. 8 is a perspective view of an alternative inspection system for inspecting a person.

### DETAILED DESCRIPTION OF THE INVENTION

The systems described herein include a sensor system for detecting a physical characteristic of a person and/or an item on the person. A “person,” as described throughout this description, includes any person attempting to gain access to a restricted area. For example, a person may be a passenger attempting to gain access to an aircraft. Further, a “physical characteristic,” as described throughout this description, includes a temperature, a size, a shape, and/or any other measurable physical characteristic. As used herein, the term “unusual,” when referring to a physical characteristic, is a characteristic that is not within a predetermined range, model, and/or threshold. For example, an unusual physical characteristic is a physical characteristic having a measured value that is a statistical outlier. Moreover, an “item on a person,” as described throughout this disclosure, includes any item that a person may carry, wear, transport, and/or otherwise possess on, near, or in the person's body. For example, an item on a person may be a shoe that is worn by the person into the restricted area.

Particular reference will be made throughout this description to a person that is screened for a “target material.” However, it is to be understood that the present invention is not so limited and that many other applications are envisioned and possible within the teachings of this disclosure. For example, the inspection systems described herein may be implemented in seaports, public buildings, public transportation facilities, prisons, hospitals, power plants, court houses, office buildings, hotels, casinos, and/or any other suitable location. Additionally, the inspection systems described herein may also be used to inspect any suitable object.

Further, as used herein, a “target material” is any material for which the inspection process is performed to detect. In the exemplary embodiment, the target material is contraband, such as illegal substances, explosives, narcotics, weapons, a threat object, and/or any other material that a person is not allowed to possess. Moreover, although “security personnel” are referred to herein, any suitable third party may monitor, control, and/or otherwise operate the inspection system described herein to inspect a person and/or an object. As such, the terms “security personnel” and “third party” are used interchangeably herein.

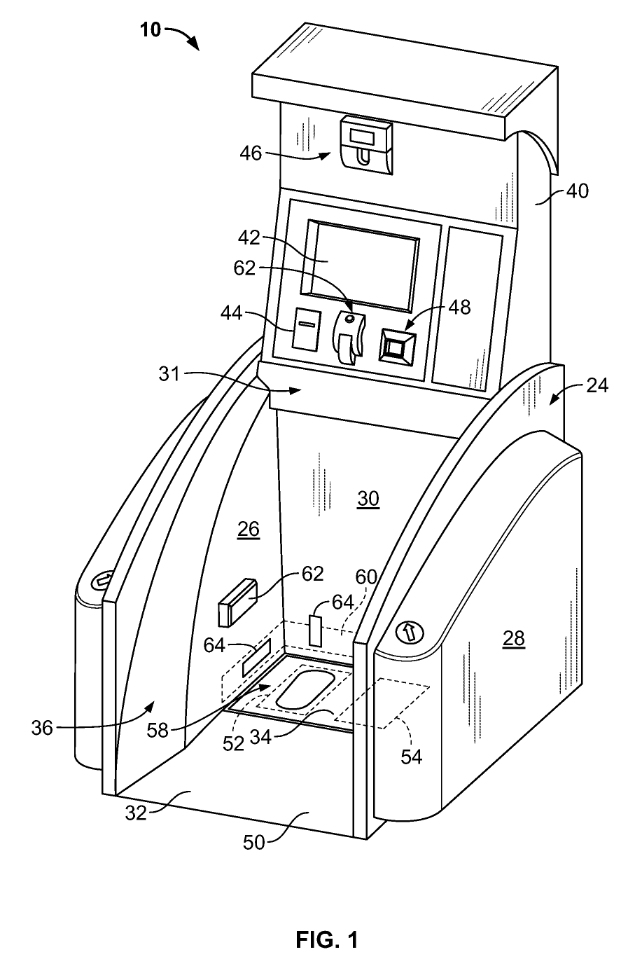

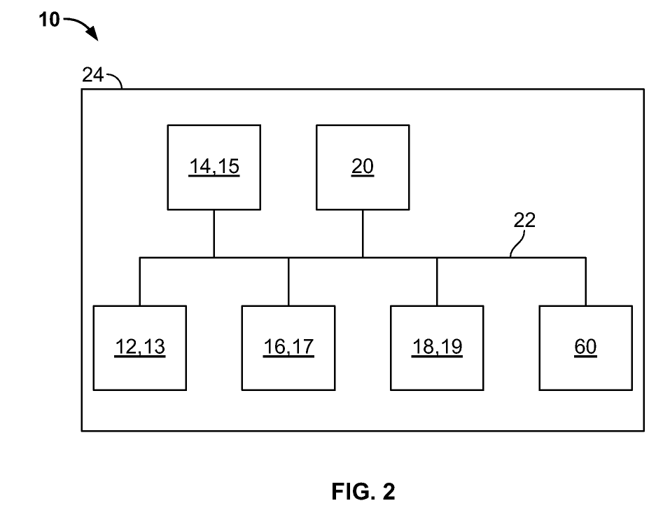

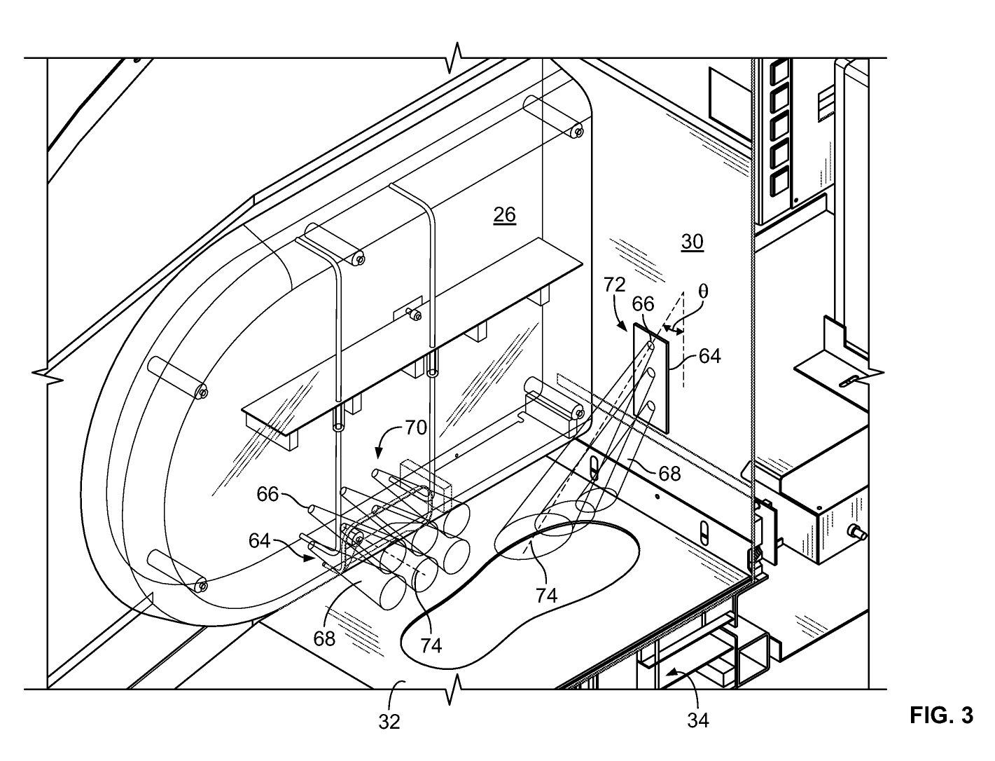

FIG. 1 is a perspective view of an exemplary inspection system 10. FIG. 2 is a simplified schematic illustration of inspection system 10. FIG. 3 is perspective view of a sensor system 64 that may be used with inspection system 10. As shown in FIG. 2, and in the exemplary embodiment, inspection system 10 includes at least a first modality 12, referred to herein as an identity verification system 13, a second modality 14, referred to herein as a screening system 15, a third modality 16, referred to herein as a characteristic detection system 17, and a fourth modality 18, referred to herein as a metal detection system 19.

Inspection system 10 includes at least one computer 20 and a communications bus 22, which is coupled between modalities 12, 14, 16, and 18, and computer 20 to enable operator commands to be sent to at least one modality 12, 14, 16, and/or 18 and to allow outputs generated by modalities 12, 14, 16, and 18 to be delivered to computer 20 and/or used by computer 20 for data analysis or utilized by an operator of computer 20. In one embodiment, modalities 12, 14, 16, and 18 are hardwired to computer 20. In an alternative embodiment, communications bus 22 is a local area network (LAN). Optionally, communications bus 22 includes an internet connection.

Modalities 12, 14, 16, and 18 are integrated into a single inspection system 10. In the exemplary embodiment, modalities 12, 14, 16, and 18, and computer 20 are each housed within a single kiosk or housing 24. Optionally, computer 20 is housed separately from kiosk 24 and electrically coupled to modalities 12, 14, 16, and 18 through communications bus 22. As used herein, a “kiosk” is defined as a relatively small area that is at least partially defined by at least one wall.

Referring to FIG. 1, kiosk 24 includes a first wall 26, a second wall 28 that is positioned substantially parallel to first wall 26, and a third wall 30 that is positioned substantially perpendicular to and coupled between first wall 26 and second wall 28. More specifically, third wall 30 is coupled between first wall 26 and second wall 28 to at least partially enclose a passenger screening area 31. Kiosk 24 also includes a floor 32 extending between first wall 26, second wall 28, and third wall 30. In the exemplary embodiment, floor 32 includes an inductive sensor 34 that is described in further detail below. For example, and as shown in FIG. 1, walls 26, 28, and 30 define a single opening 36 such that a person may enter and exit kiosk 24 through opening 36. Details of the exemplary embodiment of kiosk 24 can be found in U.S. application Ser. No. 11/456,748, filed Jul. 11, 2006 and/or U.S. application Ser. No. 11/456,742, filed Jul. 11, 2006. Optionally, kiosk 24 may include first wall 26 and second wall 28, but not third wall 30, such that the passenger may enter kiosk 24 through a first opening, proceed through kiosk 24, and exit kiosk 24 through a second opening.

In the exemplary embodiment, kiosk 24 also includes a control panel section 40 that is coupled to third wall 30 and extends upwardly from third wall 30 to a predetermined height to facilitate providing various operator controls that are used by a person to operate inspection system 10. Control panel section 40 also includes a monitoring or display device 42 that can be used to prompt a person to either input selected information into inspection system 10 and/or prompt a person to perform various actions within inspection system 10 to facilitate expediently verifying the identity of the person and inspect the person for a target material, as described herein.

In the exemplary embodiment, to facilitate verifying a person's identity, inspection system 10 includes an electronic card reader 44. In the exemplary embodiment, carder reader 44 includes a receptacle configured to receive a person's registration card. For example, in the exemplary embodiment, the person's registration card includes biometric information of the person that has been encoded onto the registration card obtained by the person during a prescreening process. For example, a person may obtain a registration card by registering with the Registered Traveler Program (RTP). In registering with the RTP, the person is pre-screened by the TSA or some other authorized screening entity, to obtain biometric information that is then stored on the person's registration card. The biometric information may include the person's fingerprints, iris scan information, hand print information, voice recognition information, and/or other suitable biometric information. The information on the registration may be encoded on a magnetic strip, use optical read codes, use an RF-read memory chip, and/or other embedded media.

The information collected during the prescreening process is then stored within or provided to inspection system 10, for example, via electronic card reader 44 reading the registration card, such that when the person enters kiosk 24, the verified information is compared to the information presented by the person within kiosk 24 to facilitate reducing the amount of time to complete screening a person and thus improve the convenience of screening. In the exemplary embodiment, during operation of inspection system 10, the person inserts his/her registration card into electronic card reader 44. Identity verification system 13 then prompts the person to position a selected body part, such as an eye and/or a fingertip, on a sensor that is utilized to collect biometric information from the person within kiosk 24. The collected information is then compared to the biometric information stored on the registration card to verify the identity of the person.

In the exemplary embodiment, identity verification system 13 is implemented utilizing an iris scan device 46 to generate biometric information that is then compared to the information on, for example, the Registered Traveler's registration card, in order to verify that the person being screened is the person to whom the card in fact belongs. In an alternative embodiment, identity verification system 13 is implemented utilizing a fingerprint scan device 48. A person places a finger on fingerprint scan device 48 such that fingerprint scan device 48 obtains an image of the fingerprint of the person for verification. Optionally, identity verification system 13 is implemented by using a hand scanning device, a facial image recognition system, and/or a voice recognition system in order to verify the identity of the person.

In the exemplary embodiment, screening system 15 is implemented using a quadrupole resonance (QR), or nuclear quadrupole resonance (NQR), detection system that uses quadrupole resonance to detect explosives such as, but not limited to, C4, Semtex, Detasheet, TNT, ANFO, and/or HMX. More specifically, the QR detection system is configured similarly to the quadrupole resonance system described in U.S. application Ser. No. 11/456,748. In the exemplary embodiment, the QR detection system includes a radio frequency source, a pulse programmer and RF gate, and an RF power amplifier that are configured to generate a plurality of radio frequency pulses having a predetermined frequency to be applied to a coil, such as inductive sensor 34. More specifically, inductive sensor 34 is positioned proximate third wall 30 approximately between first wall 26 and second wall 28. In one embodiment, inductive sensor 34 is positioned within a recessed region (not shown) of floor 32, between an entrance ramp 50 and third wall 30. The recessed region may also be referred to as a sensor housing.

During operation of inductive sensor 34, in the exemplary embodiment, the person stands with his/her left foot positioned relative to a first current branch 52 of inductive sensor 34 and his/her right foot positioned relative to second current branch 54 of inductive sensor 34. Inductive sensor 34 then performs the screening process using NQR to detect the presence of a target material associated with the person. In the exemplary embodiment, current flows between first current branch 52 and second current branch 54 during operation since first current branch 52 and second current branch 54 are electrically coupled via entrance ramp 50 and/or the sensor housing. As such, current is directed oppositely through each branch resulting in current flowing from toe to heel along first current branch 52, and from heel to toe along second current branch 54. In the exemplary embodiment, inductive sensor 34 is positioned within the sensor housing to form a non-conductive gap between first current branch 52 and second current branch 54. The gap enables the magnetic fields to circulate about first current branch 52 and second current branch 54.

In the exemplary embodiment, metal detection system 19 includes a pair metal detection coils 56 in conjunction with inductive sensor 34. Each metal detection coil 56 is configured to detect a target material, such as conductive objects, present within the vicinity of the lower extremities of the inspected person. An example of metal detection system 19 is described in U.S. application Ser. No. 11/456,748 and/or U.S. application Ser. No. 11/456,742. Signals generated by metal detection system 19 are communicated to a suitable computing device, such as, computer 20. Moreover, metal detection system 19 generally relies on the similarity of metallic parts in shoes and/or on the presence of a metallic object skewing the symmetry of the metal distribution between the person's feet, which skews the magnetic field generated about the person. As such, to facilitate optimizing the performance of system 10, the person's feet are placed nearly symmetrically over QR coils 58 of the QR detection system and between metal detection coils 56 of metal detection system 19 such that misplacement of a foot does not generate a false asymmetry alarm. Accordingly, a positioning device 60 is used to determine the placement of each foot within the inspection system 10.

More specifically, to facilitate optimizing the identification and screening operation of inspection system 10, the person being inspected is positioned within inspection system 10 such that the person's feet are positioned within a predetermined screening area to provide optimal screening conditions for both the first, second, and third screening modalities. Accordingly, inspection system 10 includes positioning device 60 for determining that the person's feet are within the predetermined area. More specifically, the volume of space interrogated by screening system 15 and/or metal detection system 19 is finite, and as such, positioning device 60 also facilitates ensuring that the person's feet remain within the interrogation volume, for example, the predetermined screening area, throughout a scan period. Positioning device 60 may include any position verification device described in U.S. application Ser. No. 11/456,748.

In the exemplary embodiment, screening system 15 is alternatively, or additionally, implemented using a fingertip trace explosive detection system 62. Fingertip trace explosive detection system 62 is configured to detect minute particles of interest such as traces of a target material, such as narcotics, explosives, and/or other contraband on the person's finger and/or hand, for example. In the exemplary embodiment, fingertip trace explosive detection system 62 is located proximate to a boarding pass scanner (not shown) such that, as the person scans the boarding pass, at least a portion of the person's hand passes over fingertip trace explosive detection system 62. Optionally, the person is prompted to press a button to activate fingertip trace explosive detection system 62 such that the trace target materials on the finger surface are collected and then analyzed by fingertip trace explosive detection system 62.

In the exemplary embodiment, third modality 16, or characteristic detection system 17, includes a sensor system 64 having an array of sensors 66, as shown in FIG. 3. Alternatively, sensor system 64 may includes at least one sensor 66. In the exemplary embodiment, sensor 66 is configured to detect at least one physical characteristic of the person's body and/or item on the person, such as the person's shoes. In an alternative embodiment, the array of sensors 66 includes a plurality of types of sensors. For example, the array of sensors 66 includes at least one temperature sensor, at least one shape sensor, and/or at least one position sensor. Alternatively, the array of sensors 66 includes a plurality of the same type of sensor. In the exemplary embodiment, sensor system 64 also includes a database of pre-stored physical characteristics to which a measured physical characteristic is compared. The database is in communication with sensor system 64 and may be within computer 20 or separate from computer 20. In the exemplary embodiment, sensor 66 measures a physical characteristic of the person and/or the item on the person to pre-stored statistical data within the database to determine if the measured characteristic is a statistical outlier. A statistical outlier may indicate the presence of and/or activity near a target material.

In an alternative embodiment, sensor system 64 includes a camera for imaging a person's feet in inspection system 10. More specifically, the camera may be a video camera, an infrared camera, and/or any other suitable type of camera. The camera is in communication with computer 20 for displaying and/or analyzing images generated by the camera. For example, when an image is displayed, a third party can inspect the person's shoes and/or the person can see the position of his/her feet to ensure correct positioning within inspection system 10. Upon inspection of the person's shoes and/or feet by the third party, the person may be prompted to reposition her/her feet and/or may be further inspected. In another example, computer 20 includes software, such as machine vision software, for analyzing an image of the person's foot and/or feet to alarm and/or prompt the person to reposition his/her foot and/or feet. In still another embodiment, floor 32 includes footprint shaped indicators thereon that indicate an optimal and/or proper position for each foot. The camera images the person's feet and/or foot to verify that the footprint shaped indicators, and/or a predetermined portion thereof, are concealed by the person's feet.

More specifically, in the exemplary embodiment, sensor 66 is a temperature sensor that measures a temperature of each of the person's shoes. For example, sensor 66 is a thermopile that is a non-contact infrared temperature sensor. Alternatively, sensor 66 may be a non-contact temperature sensor, an infrared temperature sensor, a contact temperature sensor, and/or any other suitable temperature sensor. In the exemplary embodiment, each sensor 66 includes a sensing zone 68 that is represented in FIG. 3 as a cone. Each sensor 66 measures a temperature of an object, such as the person's foot, that intercepts sensing zone 68.

In the exemplary embodiment, a plurality of sensors 66 are positioned adjacent the person's feet on, for example, first wall 26, second wall 28, and/or third wall 30. More specifically, inspection system 10 includes a first array 70 of sensors 66 on each of first wall 26 and second wall 28 and a pair of a second arrays 72 of sensors 66 on third wall 30. More specifically, each first array 70 is configured to measure a temperature at at least one of the person's ankle, heel, and/or side of the foot, and each second array 72 is configured to measure a temperature at at least one of the top and/or front of the person's foot. Each of the pair of second arrays 72 is positioned adjacent one of the person's feet. Output of sensors 66 of arrays 70 and/or 72 are combined to generate a temperature profile, an average temperature, and/or other suitable indication of the temperature of the person's feet and/or shoes.

In the exemplary embodiment, each sensor 66 of first array 70 is oriented laterally such that an axis 74 of a respective sensing zone 68 is substantially perpendicular to floor 32. Further, each sensor 66 of second array is oriented obliquely such that axis 74 of a respective sensing zone 68 is oriented at an acute angle 0 to third wall 30. Alternatively, axes 74 of sensors 66 in first array 70 and/or second array 72 may be oriented at any suitable angle to walls 26, 28, and/or 30 and/or to floor 32 that enables inspection system 10 to function as described herein. In the exemplary embodiment, sensors 66 are oriented toward the person's feet and/or shoes to measure a general local temperature and/or temperature gradient of and/or proximate the person's lower extremities, such as the person's feet and/or shoes. More specifically, sensors 66 are oriented and/or positioned to measure predetermined portions of the person's feet and/or shoes.

In an alternative embodiment, sensor system 64 includes contact temperature sensors 66 positioned on floor 32 such that the person stands on sensors 66 when positioned within kiosk 24. More specifically, when the person's stands on sensors 66, sensor system 64 measures the temperature of the person's feet and/or shoes.

In the exemplary embodiment, sensor 66 and the database are used to determine if any unusual physical characteristic is present. As discussed above, an unusual physical characteristic is a physical characteristic having a measured value that is not within a predetermined range, model, and/or threshold, such as a statistical outlier. For example, shoes having a measured temperature that is above or below a predetermined range of temperatures are considered to be unusual. More specifically, in the exemplary embodiment, the unusualness of the person's lower extremities, such as the shoes, is determined by comparing the measured temperature and/or temperature gradient to pre-stored temperatures and/or temperature gradients within the database. An unusual temperature and/or temperature gradient may warrant further screening of the person's lower extremities. Further, having shoes within a predetermined temperature range facilitates optimizing the performance of a QR sensor, such as inductive sensor 34. Accordingly, a shoe having a temperature falling outside of the predetermined temperature range may be screened using detection systems other than inductive sensor 34.

In an alternative embodiment, sensor 66 is a sensor configured to determine the shape and/or configuration of a shoe and/or a foot and compare the sensed shape and/or configuration with pre-stored shapes and/or configurations, such as a statistical model of shoe shapes, within the database. In such an embodiment, sensor 66 is, but is not limited to being, an infrared sensor, an ultrasound probe, a capacitive sensor, and/or an inductive sensor. In the exemplary embodiment, sensor system 64 includes an array of infrared sensors 66 for determining a size, shape, and/or position of the person's foot and/or shoe. Alternatively, sensor system 64 includes at least one infrared sensor 66 for determining a size, shape, and/or position of the person's foot and/or shoe. In the exemplary embodiment, sensor 66 includes a transmitter and a receiver with an infrared beam extending therebetween.

If the person's foot and/or shoe intercepts the infrared beam, an alarm is indicated and/or the person is prompted to reposition the foot. As such, sensor 66 is positioned with respect to kiosk 24 such that a statistical average foot and shoe will not intercept the infrared beam. In one embodiment, sensor system 64 includes an array of sensors 66 in the shape of an outline of a statistically average foot and/or shoe such that statistically unusual feet and/or shoes will break at least one infrared beam and a statistically average foot and/or shoe will be surrounded by infrared beams. Alternatively, sensors 66 configured to sense shape and/or configuration are positioned and/or oriented in any suitable manner than enables inspection system 10 to function as described herein. In the exemplary embodiment, in addition to detecting unusual characteristics of the person's feet and/or shoes, sensors 66 configured to sense shape and/or configuration to facilitate properly and/or optimally positioning the person's feet within kiosk 24.

In the exemplary embodiment of sensor 66 configured to sense shape and/or configuration, if sensor 66 detects a cubically-shaped shoe, inspection system 10 alerts security personnel such that the shoe and/or the person may be further screened. Further, an usually long and/or wide shoe may be indicative to the presence of a target material within a shoe. Accordingly, sensor system 64 facilitates detecting unusual physical characteristics of the person and/or the item on the person to determine if a target material is present and/or if the person was near a target material before entering kiosk 24.

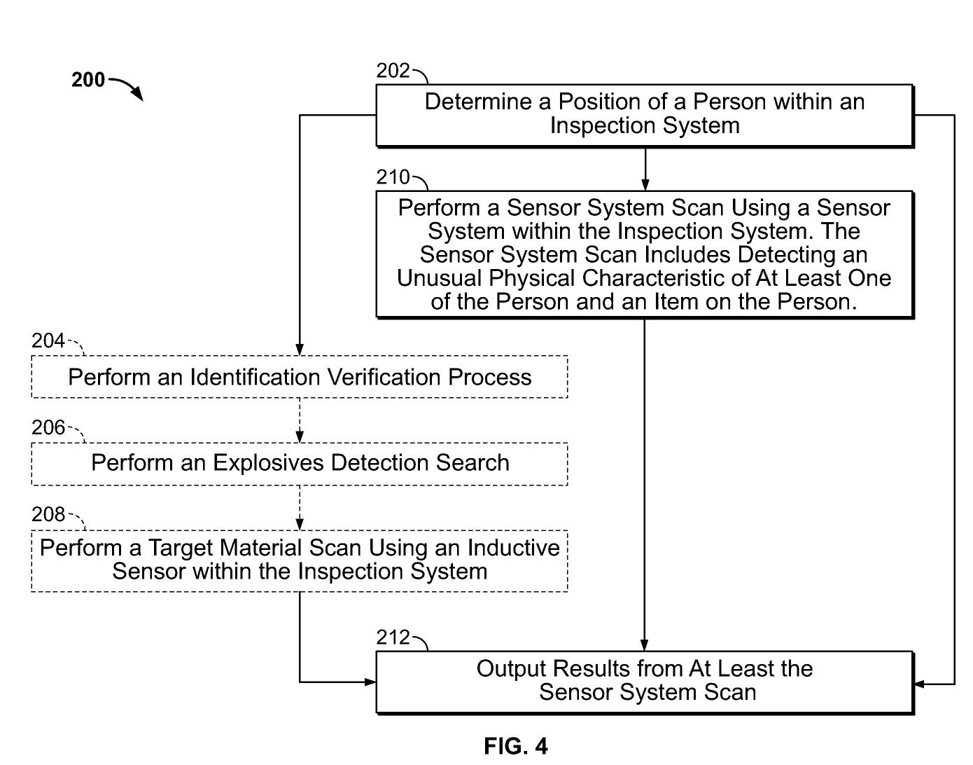

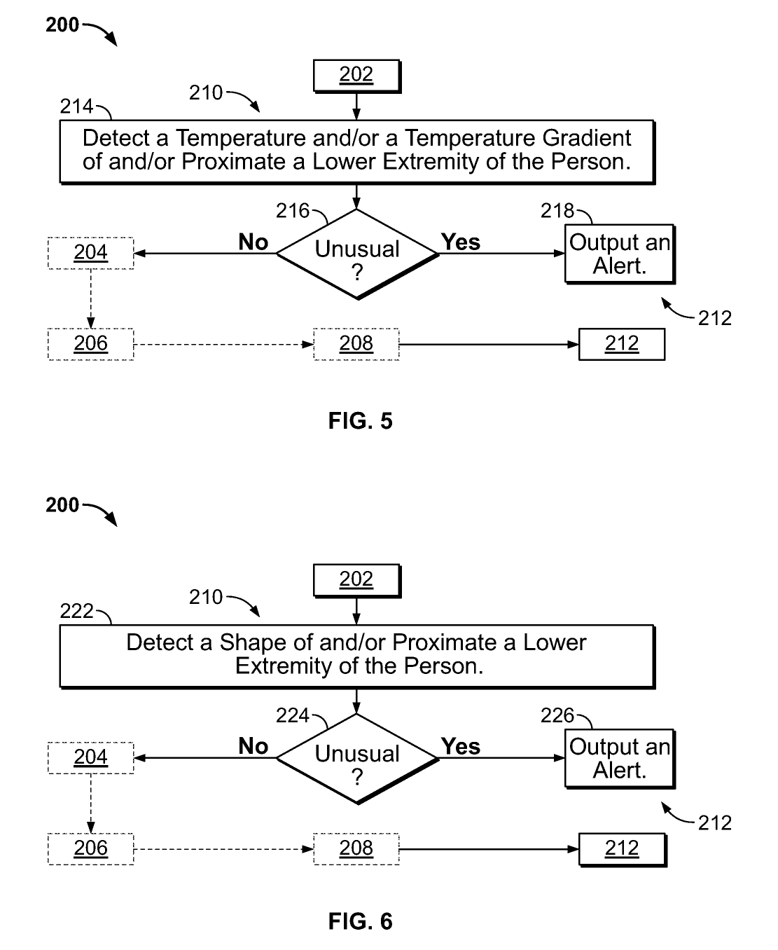

FIG. 4 is a flowchart of an exemplary embodiment of an inspection process 200 for inspecting a person that may be used with inspection system 10 (shown in FIGS. 1-3) and/or with inspection system 100 (shown in FIG. 5). Referring to FIGS. 1-4, inspection system 10 performs inspection process 200 that includes performing a position determination 202, a verification process 204, an explosives detection search 206, a target material scan 208 and/or a sensor system scan 210, in any suitable order and/or simultaneously.

To use inspection system 10 to screen a person, a position of person within inspection system 10 is determined 202. More specifically, inspection system 10 determines 202 whether the person is within kiosk 24 using positioning device 60 and/or sensor system 64. In one embodiment, determining 202 the position of the person include using sensor system 64 to determine whether at least feet of the person are properly positioned within inspection system 10. In the exemplary embodiment, after the person's position is determined 202, sensor system 64 determines whether the person and/or an item on the person has any unusual physical characteristics by performing 210 the sensor system scan. More specifically, as described herein, sensor system 64 determines if any statistically outlying measurements, such as temperature and/or shoe geometry, are measured by sensor 66, as described herein. Results of the sensor system scan are output 212 by inspection system 10. If an unusual physical characteristic is present, security personnel are alerted for further screening of the person.

In an alternative embodiment, after inspection system 10 has determined 202 that the person to be inspected is within kiosk 24, inspection system 10 then prompts the person to enter identity information to perform 204 the optional verification process. For example, as discussed above, kiosk 24 may request that a person enter a registration card having the person's previously verified biometric information into electronic card reader 44. Inspection system 10 then automatically prompts the person to place a body part onto one of the identity verification systems. For example, inspection system 10 may prompt the person to place at least one eye in front of iris scan device 46. Inspection system 10 then determines whether the person's eye is positioned in front of iris scan device 46 and automatically initiates scanning the person's eye to produce an image of the iris as discussed above. The generated image is then compared to the biometric information stored on the person's registration card to verify the identity of the person. Alternatively, inspection system 10 automatically prompts the person to place a finger on fingerprint scan device 48 to perform 204 the verification process. Inspection system 10 then determines whether the person's finger is positioned on fingerprint scan device 48 and automatically initiates scanning the person's finger to produce an image of the fingerprint, as discussed above. The generated image is then compared to the biometric information stored on the person's registration card to verify the identity of the person. In the exemplary embodiment, results of the verification process are output 212 by inspection system 10. If the person's identity is not verified, inspection system 10 alerts security personnel so a further screening of the person may be performed.

In a further alternative embodiment, after the identity of the person has been verified 204, inspection system 10 prompts a person to perform 206 the optional explosives detection search. For example, inspection system 10 prompts the person to press her thumb on fingertip trace explosive detection system 62. In the exemplary embodiment, fingertip trace explosive detection system 62 is configured to determined whether the person's finger is positioned on fingertip trace explosive detection system 62 and to automatically initiate a trace explosives scan on the fingertip of the person within kiosk 24 in a relatively short time period, thus decreasing the time required to inspect a person for explosives. Results of the explosives detection search are output 212 by inspection system 10. If explosives are present, inspection system 10 alerts security personnel to perform a further search.

To facilitate performing 208 the optional target material scan, such as a metal scan and/or an explosives scan, of the lower leg and feet region of the person, inspection system 10 is configured to automatically prompt the person to correctly position her feet within kiosk 24. Inspection system 10 then determines the relative location of a person's feet within inspection system 10 to verify that the person's feet are positioned within the predetermined screening area. In the exemplary embodiment, the position of the person's feet within kiosk 24 is determined using positioning device 60 described above. Once both foot are positioned correctly within the predetermined screening area, inspection system 10 automatically initiates and performs 208 the target material scan, such as a metal detection and/or explosive scan, to screen the person, as described herein. Results of the target material scan are output 212 by inspection system 10. If a target material, such as metal and/or an explosive material, is detected during target material scan, inspection system 10 notifies security personnel for further screening of the person.

FIG. 5 is a flowchart of a first alternative embodiment of method 200. More specifically, FIG. 5 illustrates method 200 when sensor 66 is configured to determine a temperature and/or temperature gradient of and/or proximate a lower extremity of the person. In the exemplary embodiment, performing 210 the sensor system scan includes detecting 214 a temperature and/or temperature gradient of and/or proximate a lower extremity of the person after the position of the person has been determined 202. After the temperature and/or temperature gradient is detected 214, the detected temperature and/or temperature gradient is compared to a predetermined range, model, and/or threshold to determine 216 if the measured temperature and/or temperature gradient is unusual. If the measured temperature and/or temperature gradient is unusual, outputting 212 includes outputting 218 the results of the sensor system scan as an alert. More specifically, the alert alerts the third party that a further search and/or inspection of the person may be necessary. For example, when the alert is output 218, a non-NQR scan is performed to detect a target material associated with the person.

If the measured temperature and/or temperature gradient is not unusual, inspection system 10 performs at least one of the verification process 204, the explosives detection search 206, and/or the target material search 208 and outputs 212 the results of the verification process 204, the explosives detection search 206, and/or the target material search 208.

FIG. 6 is a flowchart of a second alternative embodiment of method 200. More specifically, FIG. 6 illustrates method 200 when sensor 66 is configured to determine a shape of and/or proximate a lower extremity of the person. In the exemplary embodiment, performing 210 the sensor system scan includes detecting 222 a shape of and/or proximate a lower extremity of the person after the position of the person has been determined 202. After the shape is detected 222, the detected shape is compared to a predetermined range, model, and/or threshold to determine 224 if the measured shape is unusual. If the measured shape is unusual, outputting 212 includes outputting 226 the results of the sensor system scan as an alert. More specifically, the alert alerts the third party that a further search and/or inspection of the person may be necessary.

If the measured temperature and/or temperature gradient is not unusual, inspection system 10 performs at least one of the verification process 204, the explosives detection search 206, and/or the target material search 208 and outputs 212 the results of the verification process 204, the explosives detection search 206, and/or the target material search 208.

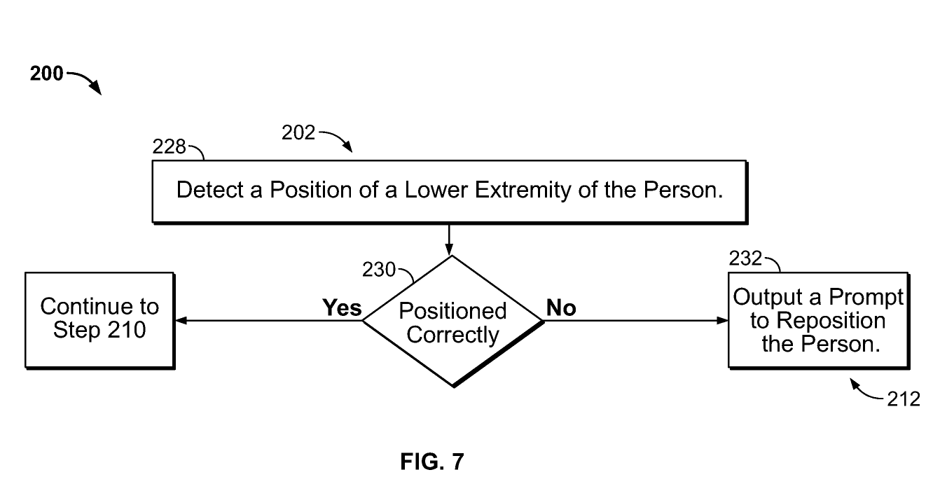

FIG. 7 is a flowchart of a third alternative embodiment of method 200. More specifically, FIG. 7 illustrates method 200 when sensor 66 is configured to determine a position of a lower extremity of the person. In the exemplary embodiment, determining 202 the position of the person includes detecting 228 a position and/or a shape of a lower extremity of the person, such as the person's foot. After the position is detected 228, the detected position is compared to a predetermined position of the person to determine 230 if the measured position is a correct position. If the measured position is not correct, outputting 212 includes outputting 232 the results of the sensor system scan as an alert. More specifically, the alert prompts the person to reposition himself/herself within inspection system 10 and/or alerts a third party to the incorrect position of the person. The third party may assist in correctly positioning the person and/or further search and/or inspect the person.

If the measured position is correct, inspection system 10 performs 210 at least the sensor system scan for an unusual characteristic. The position detection 228 can be considered to be the sensor system scan performance 210 or can be considered to be separate from the sensor system scan performance 210. For example, while sensor system 64 is detecting 228 the position, sensor system 64 can also be performing 210 the sensor system scan for a physical characteristic, such as temperature and/or shape. As such, steps 228 and 210 can be performed simultaneously by the same sensor system 64. Results of step 228 and/or step 210 are output 212 by inspection system 10. Further, inspection system 10 may also perform one of the verification process 204, the explosives detection search 206, and/or the target material search 208 and output 212 the results of the verification process 204, the explosives detection search 206, and/or the target material search 208.

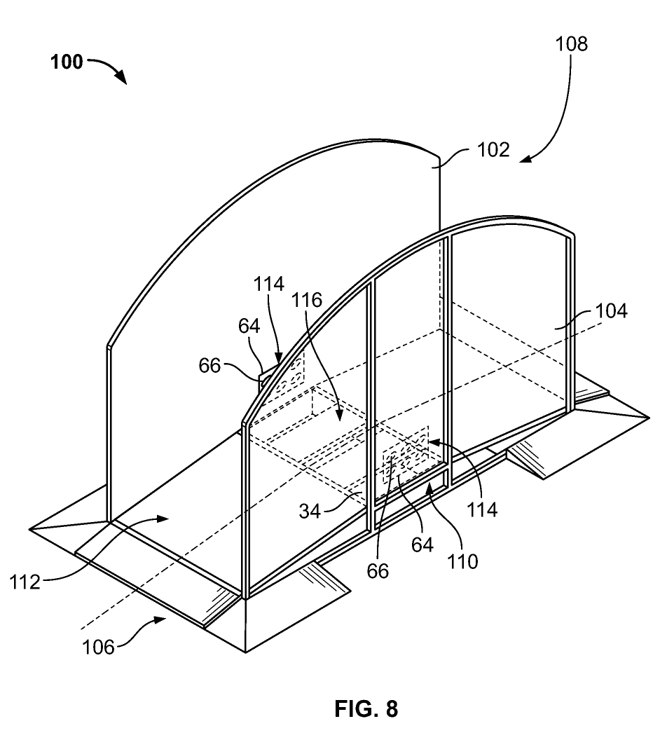

FIG. 8 is a perspective view of an alternative inspection system 100 including sensor system 64, as described in more detail above. Inspection system 100 is a walkthrough scanner that includes a first wall 102 and a second wall 104. Inspection system 100 is described herein as a walkthrough inspection system implemented as part of a typical aviation security system and, more particularly, as a scanner configured to scan the lower extremities and/or shoes of a person. However, it should be understood that inspection system 100 may be used to scan objects other than a person. Inspection system 100 includes an open-access entrance 106 and exit 108, which are defined by the substantially U-shaped design of the structure of inspection system 100. In an alternative embodiment, inspection system 100 may include gates, doors, and/or other enclosure devices at entrance 106 and/or exit 108, for example. Details of inspection system 100 are described in U.S. Pat. No. 7,365,536, issued Apr. 29, 2008.

In the exemplary embodiment, inductive sensor 34, as described in more detail above, is located within inspection system 100. More specifically, inductive sensor 34 may be positioned within a sensor housing 110 of a walkway 112 extending between entrance 106 and exit 108. Sensor housing 110 is also referred to herein as a recessed region although, in the exemplary embodiment, inductive sensor 34 may be mounted to a non-recessed sensor housing, mounted onto a substantially flat portion of walkway 112, and/or be positioned with respect to first wall 102 and/or second wall 104 at any suitable location that enables inspection system 100 to function as described herein. When inductive sensor 34 is mounted to a non-recessed sensor housing, the person steps up and onto the non-recessed sensor housing for inspection. Inductive sensor 34 and/or the volume surrounding inductive sensor 34 may also be considered to be a “screening system.” In the exemplary embodiment, inductive sensor 34 is configured similarly to the QR sensor described in U.S. Pat. No. 7,365,536.

In the exemplary embodiment, inductive sensor 34 provides explosives screening, for example, as part of inspection system 100, however inductive sensor 34 may be configured to cooperate with other types of inspection and detection systems, such as metal detection, vapor trace, and/or any other suitable inspection systems. For example, a QR inspection system may be integrated with a walkthrough detection portal equipped with a trace detection system.

In the exemplary embodiment, inspection system 100 includes sensor system 64, described in more detail above, and is considered to be a “characteristic detection system.” More specifically, in the exemplary embodiment, each sensor 66 of an array 114 is oriented laterally such that an axis of a respective sensing zone is substantially perpendicular to a floor 116 of inspection system 100 and/or is oriented obliquely such that the axis of a respective sensing zone is oriented at an acute angle to first wall 102 and/or second wall 104. Alternatively, the axes of sensors 66 may be oriented at any suitable angle to walls 102 and/or 104 and/or to floor 116 that enables inspection system 100 to function as described herein. In the exemplary embodiment, sensors 66 are oriented toward the person's feet and/or shoes to measure a general local temperature and/or temperature gradient of the person's feet and/or shoes. More specifically, sensors 66 are oriented and/or positioned to measure predetermined portions of the person's feet and/or shoes.

In an alternative embodiment, sensor system 64 includes contact temperature sensors 66 positioned on floor 116 such that the person stands on sensors 66 when positioned within inspection system 100. More specifically, when the person stands on sensors 66, sensor system 64 measures the temperature of the person's feet. In still another alternative embodiment, when inspection system 100 includes traffic control gates that are configured to prevent the person from proceeding to exit 108, a second array of sensors 66 is positioned on each traffic control gate. More specifically, each sensor 66 of the second array is configured similarly to sensors 66 of second array 72 (shown in FIG. 3), and each sensor 66 of array 114 is configured similarly to sensors 66 of first array 70 (shown in FIG. 3).

Inspection system 100 performs an inspection process that includes at least a sensor system scan. More specifically, inspection 100 performs method 200 as illustrated in FIGS. 4-7, and described in more detail above.

In one example of performing an inspection process using inspection system 100, during the inspection process of a person, the person enters inspection system 100 at entrance 106, proceeds along walkway 112, and stands with her feet positioned over inductive sensor 34, within an inspection region defined to include inductive sensor 34. More specifically, the person stands with her left foot positioned relative to a first current branch and her right foot positioned relative to a second current branch of inductive sensor 34. Inductive sensor 34 then performs the target material scan using, in the exemplary embodiment, nuclear quadrupole resonance (NQR) to detect the presence of a target material associated with the person. Results of the target material scan are output by inspection system 100. If a target material is detected during the target material scan, inspection system 100 alerts security personnel such that a further search of the person may be performed. In an alternative embodiment, during the target material scan, inspection system 100 uses inductive sensor 34 to additionally, or alternatively, detect metallic objects, such as guns, ice picks, knives, razors, and/or other metallic objects that may be used as weapons, present near the lower extremities of the inspected person.

In the exemplary embodiment, after the person is positioned within inspection system 100 in the inspection region, sensor system 64 determines whether the person and/or the item on the person has any unusual physical characteristics by performing the sensor system scan. More specifically, as described herein, sensor system 64 determines if any statistically outlying measurements, such as temperature and/or shoe geometry, are measured by sensor 66. Results of the sensor system scan are output by inspection system 100. If an unusual physical characteristic is present, security personnel are alerted for further screening of the person. In one embodiment, a non-NQR scan is performed if an unusual physical characteristic is present.

The inspection systems described herein facilitate quickly and accurately inspecting a person for a target material and/or other contraband. More specifically, by including at least an inductive sensor for detecting metal and/or explosives and a sensor system for detecting an unusual physical characteristic, multiple types of materials and/or objects can be detected within a relatively short period of time, as compared to scanning a person with separate inspections systems in series. Further, when the sensor system described herein includes a temperature sensor, performance of a QR sensor is optimized. Moreover, by detecting unusual physical characteristics of a person and/or an item on the person, the inspection systems described herein facilitate reducing a number of false negatives. For example, the embodiments described herein facilitate detecting benign objects that appear to be benign but include and/or conceal the target material.

A technical effect of the embodiments described herein is detecting unusual physical characteristics of a person and/or an item on the person to facilitate reducing a number of false negatives and determining whether a person has been and/or is in possession of a target material.

Further, the inspection systems described herein detected target materials, such as contraband and/or other items of interest located in proximity to a person's footwear, socks, trousers, and/or other apparel items present at the lower extremities. Accordingly, footwear, socks, and/or other clothing items need not be removed prior to inspection because such items can be inspected by the QR inspection system while being worn by the person. Since the inspected person is not required to remove such items before inspection, the QR inspection system is especially suited for the non-intrusive inspection of persons as part of a multi-station, airport screening checkpoint.

Exemplary embodiments of a method and an inspection system are described above in detail. The method and inspection system are not limited to the specific embodiments described herein, but rather, components of the inspection system and/or steps of the method may be utilized independently and separately from other components and/or steps described herein. For example, the method may also be used in combination with other screening and/or inspection systems and methods, and are not limited to practice with only the inspection system and method as described herein. Rather, the exemplary embodiment can be implemented and utilized in connection with many other material detection applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method, comprising:
determining a position of a person within an inspection system;
performing a sensor system scan using a sensor system within the inspection system, the sensor system scan including detecting an unusual physical characteristic of at least one of the person and an item on the person; and
outputting results from the sensor system scan.

2. A method in accordance with claim 1, further comprising performing an identification verification process using an identity verification system within the inspection system.

3. A method in accordance with claim 1, further comprising performing a target material scan using an inductive sensor within the inspection system.

4. A method in accordance with claim 3, wherein performing a target material scan using an inductive sensor within the inspection system further comprises performing at least one of a metal detection scan and an explosive detection scan using the inductive sensor.

5. A method in accordance with claim 3, wherein outputting results from the sensor system scan further comprises alerting a third party to the presence of the target material.

6. A method in accordance with claim 1, wherein performing a sensor system scan further comprises:
performing the sensor system scan using at least one sensor configured to measure at least one of a temperature and a temperature gradient proximate a lower extremity of the person; and
comparing a measurement to at least one of pre-stored temperatures and pre-stored temperature gradients to determine if the measurement is a statistical outlier.

7. A method in accordance with claim 6, wherein performing the sensor system scan using at least one sensor configured to measure at least one of a temperature and a temperature gradient proximate a lower extremity of the person further comprises performing the sensor system scan using at least one of a thermopile, a contact temperature sensor, and a non-contact temperature sensor.

8. A method in accordance with claim 6, wherein outputting results from the sensor system scan further comprises outputting an indication that a non-nuclear quadrupole resonance scan is to be performed.

9. A method in accordance with claim 1, wherein performing a sensor system scan using a sensor system within the inspection system further comprises:
performing the sensor system scan using at least one sensor configured to determine a shape of an object proximate a lower extremity of the person; and
comparing the determined shape to pre-stored shapes to determine if the determined shape is a statistical outlier.

10. A method in accordance with claim 9, wherein performing the sensor system scan using at least one sensor configured to determine a shape of an object proximate a lower extremity of the person further comprises performing the sensor system scan using at least one of an infrared sensor, an ultrasound sensor, a capacitive sensor, and an inductive sensor.

11. A method in accordance with claim 1, wherein determining a position of a person within an inspection system further comprises using the sensor system to determine whether at least feet of the person are properly positioned within the inspection system.

12. A method in accordance with claim 1, wherein determining a position of a person within an inspection system further comprises determining the position of the person within a three-walled inspection kiosk.

13. A method in accordance with claim 1, wherein determining a position of a person within an inspection system further comprises determining the position of the person within a two-walled walkthrough inspection system.

14. A method in accordance with claim 1, wherein outputting results from the sensor system scan further comprises outputting a prompt to reposition the person within the inspection system.

15. A method in accordance with claim 1, wherein outputting results from the sensor system scan further comprises outputting a result of a nuclear quadrupole resonance scan.

16. An inspection system for inspecting a person for a presence of a target material, said inspection system comprising:
a screening system for performing a target material scan; and
a sensor system configured to detect an unusual physical characteristic of at least one of the person and an item on the person.

17. An inspection system in accordance with claim 16, wherein said sensor system comprises at least one sensor configured to measure at least one of a temperature gradient and a temperature of at least one of the person and an item on the person, said sensor system configured to determine if the measurement is an unusual physical characteristic.

18. An inspection system in accordance with claim 17, wherein said at least one sensor is oriented to measure the at least one of a temperature gradient and a temperature of at least one of an ankle of the person, a heel of the person, a side of a foot of the person, a top of the foot of the person, and a front of the foot of the person.

19. An inspection system in accordance with claim 16, wherein said sensor system comprises at least one sensor configured to determine a shape of an item on the person, said sensor system configured to determine if the determined shape of the item is an unusual physical characteristic.

20. An inspection system in accordance with claim 16, wherein said sensor system comprises at least one sensor configured to determine whether at least feet of the person are properly positioned within said inspection system.

21. An inspection system in accordance with claim 16, wherein said sensor system comprises a sensor array comprising at least one of a temperature sensor, a shape sensor, and a position sensor.

22. An inspection system in accordance with claim 16, further comprising a walkthrough inspection system comprising two sidewalls and a floor extending between said two sidewalls, said sensor system positioned on at least one of said two sidewalls.

23. An inspection system in accordance with claim 16, further comprising a screening kiosk comprising a first wall, a second wall, a third wall coupled between said first wall and said second wall, and a floor coupled to said first wall, said second wall, and said third wall, wherein said sensor system is coupled to at least one of said first wall, said second wall, and said third wall.
